(19) United States
(12) Patent Application Publication
(10) Pub. No.: US 2012/0096476 A1
(43) Pub. Date: Apr. 19, 2012

(54) VIRTUAL EVENT CHANNEL CONFIGURATION METHOD THROUGH COMBINATION OF EVENT CHANNELS AND EVENT MANAGEMENT APPARATUS USING THE METHOD

(75) Inventor: Moohun LEE, Daejeon (KR)

(73) Assignee: Electronics and Telecommunications Research Institute, Daejeon (KR)

(21) Appl. No.: 13/271,685

(22) Filed: Oct. 12, 2011

(30) Foreign Application Priority Data
Oct. 13, 2010 (KR) 10-2010-0099598

(51) Int. Cl. G06F 9/46

(52) U.S. Cl. 719/318

(57) ABSTRACT

A virtual event channel configuration method according to an aspect of the present invention is a method for configuring and managing at least one virtual event channel by combining a plurality of event channels, in which each of the at least one virtual event channel comprises the steps of: receiving an event from at least one event sender; registering an event subscriber who wants to subscribe the sent event and an event filter designated by the event subscriber; validating whether the event filter designated by the event subscriber has an error in a given event filter grammar; and extracting an event to be sent from the received events using the event filter, if the event filter is validated. Accordingly, an event is received by dynamically combining interesting event channels, and thus it is possible to reduce an overhead due to unnecessary event processing.

### CROSS-REFERENCE TO RELATED PATENT APPLICATION

This application claims the benefit of Korean Patent Application No. 10-2010-0099598, filed on Oct. 13, 2010, in the Korean Intellectual Property Office, the disclosure of which is incorporated herein in its entirety by reference.

### BACKGROUND OF THE INVENTION

1. Field of the Invention

The present invention relates to a virtual event channel configuration method through a combination of event channels included in physical sensors or applications in an event system of a context-aware framework and, more particularly, to a virtual event channel configuration method through a combination of event channels, which configures a virtual event channel by classifying sensor data input from various sensors according to spaces or services and combining event channels of the sensors into the virtual event channel, and an event management apparatus using the method.

2. Description of the Related Art

In the future, applications and services in the Ubiquitous era will have characteristics in which smart objects having computing and communication capabilities can recognize a dynamic environmental change and can be adapted thereto, i.e. context-aware characteristics. Context information corresponds to almost all information available at the time when a user initiates an interaction and includes information detectable by the application as a part of an application operating environment. The context information generally includes the location, identification, activity, status, etc. of a person, group and object. A context-aware service recognizes the context information by collecting and exchanging the context information and provides a service suitable to the context to the user after processing such as analysis and inference. The context-aware service can be applied to all fields of society such as medicine, education, disaster/rescue, shopping, etc., and thus it is expected to have a significant influence on the society.

To develop the context-aware service into practical application, it is necessary to solve a variety of problems such as retrieval and execution of the context-aware service, service collision between multiple users, satisfaction of users' tendencies, personalized context-aware services, etc.

An event system of a context-aware framework may be configured in various ways. For example, a conventional publication/subscription model has been used in a domain such as online news or online auction to promptly provide information to a user who wants to obtain desired information and subscribes to a publisher that provides the corresponding information. In the publication/subscription model, the message publisher does not send a message for a specific subscriber but sends the message in an asynchronous manner.

When the publication/subscription model is applied to the event system of the context-aware framework, each physical sensor or application that generates an event is the publisher and, when a subscriber interested in the event subscribes to the publisher, the subscriber can receive the interesting event. The conventional publication/subscription model has provided two types of services such as topic-based and content-based services to provide the interesting event. This publication/subscription model facilitates the extension since the publisher and the subscribers are separated from each other in a loosely coupled manner, but each subscriber should find interesting publishers one by one and subscribe to the corresponding publishers, which is problematic.

As a related technique, a sensor data processing technology, which reprocesses various information such as a user profile, preference information, schedule information, etc. as well as a physical sensor through a context manager to obtain context information and provides an active service based on the context information, has been proposed. The existing sensor data processing technology has provided a method for combining and processing events to generate context knowledge required for the repository and application for processing a new event by connecting and analyzing events that have occurred previously or various events.

However, although the existing technologies are related to the sensor data processing method for collecting sensor data and combining the sensor data with context information, the existing technologies failed to provide a solution for an overhead problem of a context manager that receives sensor data from a plurality of physical sensors, combines the sensor data with context information, and provides the resulting information to a plurality of applications. In particular, a method for efficiently processing the sensor data provided by the plurality of physical sensors has not been provided.

### SUMMARY OF THE INVENTION

The present invention has been made in an effort to solve the above-described problems associated with prior art, and an object of the present invention is to provide a virtual event channel configuration method through a combination of event channels, which configures a virtual event channel by combining event channels of a publisher that provides an interesting event in order to dynamically combine and extract events sent by a plurality of physical sensors or applications, and an event management apparatus using the method.

According to an aspect of the present invention, there is provided a virtual event channel configuration system comprising at least one virtual event channel unit comprising a combination of a plurality of event channels and an event channel control unit for configuring and managing the at least one virtual event channel unit, wherein each of the at least one virtual event channel unit comprises: an input event queue for receiving an event from at least one event sender; a subscriber and filter registration unit for registering and managing an event subscriber who wants to subscribe the sent event and an event filter designated by the event subscriber; an event filter validation unit for validating whether the event filter designated by the event subscriber has an error in a given event filter grammar; and an event extraction unit for extracting an event from the events received by the input event queue using the event filter, if the event filter is validated.

The event channel control unit may generate a new virtual event channel unit in response to a request of a user and delete an unnecessary virtual event channel unit from the at least one virtual event channel unit.

The user may be an event-based application or another virtual event channel.

Each of the at least one virtual event channel unit may further comprise an output event queue for sending the event output from the event extraction unit to a registered event subscriber.

The event subscriber may be at least one of the other virtual event channel units or event-based applications.

The event sender may be at least one of physical sensors, event-based applications, and the other virtual event channels.

According to another aspect of the present invention, there is provided a virtual event channel configuration method for configuring and managing at least one virtual event channel comprising a combination of a plurality of event channels, wherein each of the at least one virtual event channel comprises the steps of: receiving an event from at least one event sender; registering an event subscriber who wants to subscribe the sent event and an event filter designated by the event subscriber; validating whether the event filter designated by the event subscriber has an error in a given event filter grammar; and extracting an event to be sent from the received events using the event filter, if the event filter is validated.

According to still another aspect of the present invention, there is provided an event management apparatus comprising: an input event queue for receiving an event from at least one event sender; a subscriber and filter registration unit for registering and managing an event subscriber who wants to subscribe the sent event and an event filter designated by the event subscriber; an event filter validation unit for validating whether the event filter designated by the event subscriber has an error in a given event filter grammar; an event extraction unit for extracting an event from the events received by the input event queue using the event filter, if the event filter is validated; and an output event queue for sending the event output from the event extraction unit to a registered event subscriber.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a virtual event channel configuration system in accordance with a preferred embodiment of the present invention;

FIG. 2 is a detailed block diagram of a virtual event channel unit or an event management apparatus in accordance with a preferred embodiment of the present invention;

FIG. 3 is a diagram illustrating a virtual event channel configuration method in accordance with another preferred embodiment of the present invention in association with the configuration of a virtual event channel unit in accordance with a preferred embodiment of the present invention;

FIG. 4 is a diagram illustrating an example of the configuration of a virtual event channel through a combination of event channels in accordance with a preferred embodiment of the present invention; and

FIG. 5 is a flowchart illustrating a method for sending an event using the configuration of a virtual event channel in accordance with a preferred embodiment of the present invention.

### DETAILED DESCRIPTION OF THE INVENTION

The present invention will now be described more fully with reference to the accompanying drawings, in which exemplary embodiments of the invention are shown. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, A, B etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Unless otherwise defined, all terms, including technical and scientific terms, used herein have the same meaning as commonly understood by one of ordinary skill in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described in detail with reference to the accompanying drawings. Like reference numerals in the drawings denote like elements, and thus repeated descriptions will be omitted.

A context-aware system may comprise a sensor framework connected to various sensors, a context manager, an operation manager, etc.

The sensor framework maps the sensors in a physical space to a virtual space, extracts context data from sensor data, and provides the context data to the context manager, thereby assisting a context-based application to actively provide a service. Here, the sensor data may have various types of information such as voice data, image data, temperature/humidity data, user schedule data, etc. Moreover, the sensor framework serves to process the context data as well as to extract the context data, which means that the sensor framework filters and combines the sensor data.

The context manager stores and manages context information transmitted from the sensor framework and implicit knowledge inferred based on the context information. The context knowledge managed in this layer is referred to when the context-based application is executed later. Thus, the context manager provides the functions of adding or editing the context information, retrieving the context knowledge, and inferring the implicit knowledge together with a context model for expressing the context knowledge to the sensor framework.

The operation manager serves to activate the application by referring to the context knowledge and manage or control a context-based application process under execution.

As mentioned above, the event system of the context-aware framework may be configured in various ways. The present invention relates to a virtual event channel configuration method based on a publication/subscription model, which configures a virtual event channel by combining event channels, through which events are generated and sent by physical sensors or event-based applications, in response to a request of a subscriber of the virtual event channel, and transmits necessary data.

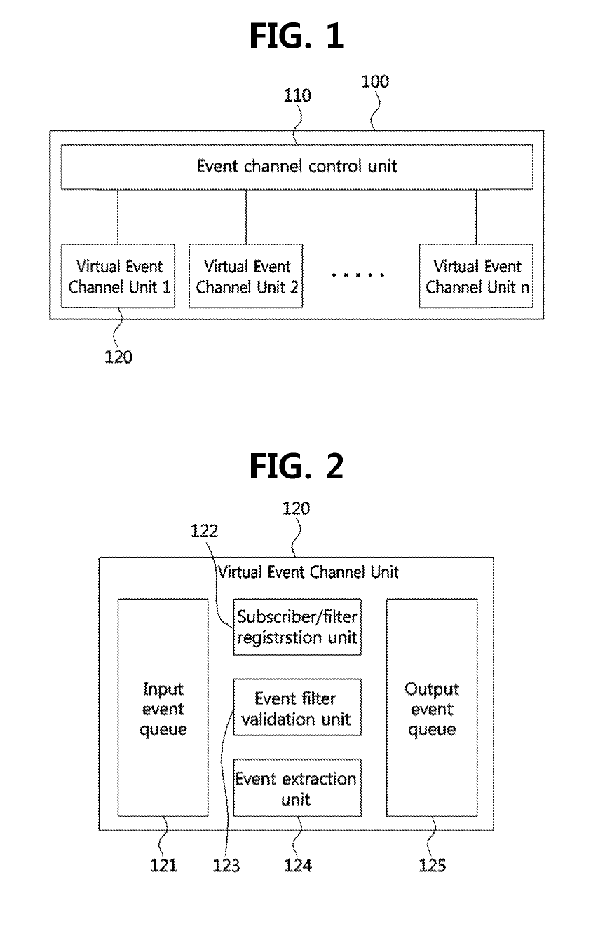

FIG. 1 is a block diagram of a virtual event channel configuration system in accordance with a preferred embodiment of the present invention.

The virtual event channel configuration system 100 in accordance with a preferred embodiment of the present invention comprises an event channel control unit 110 and at least one virtual event channel unit 120.

The event channel control unit 110 serves to configure and manage the at least one virtual event channel unit 120 by combining event channels, through which events generated and sent by physical sensors or event-based applications, in response to a request of a subscriber of a virtual event channel.

The virtual event channel unit 120 of FIG. 1 may be newly generated or may be deleted based on the management of the event channel control unit 110. That is, when there is a user's request for a virtual event channel configured by combining various new event channels, a new event channel unit may be generated. On the contrary, when all sensors and applications related to the existing virtual event channel unit and other event channel units no longer exist, the corresponding virtual event channel unit may be deleted.

The virtual event channel configuration system in accordance with a preferred embodiment of the present embodiment shown in FIG. 1 configures the virtual event channel, combines information input from various sensors, and provides a service for sending an event.

FIG. 2 is a detailed block diagram of a virtual event channel unit or an event management apparatus in accordance with a preferred embodiment of the present invention.

The virtual event channel unit 120 of FIG. 2 is an example of an event management apparatus in accordance with a preferred embodiment of the present embodiment, which can configure a virtual event channel depending on the purpose of an application or the configuration of a space.

The virtual event channel unit 120 of FIG. 2 comprises an input event queue 121 for receiving an interesting event from event channels of physical sensors or applications, a subscriber and filter registration unit 122 for registering and managing an event subscriber interested in the sent event and an event filter designated by the subscriber, an event filter validation unit 123 for validating whether an expression formula of the registered event filter has an error in a given event filter grammar, an event extraction unit 124 for extracting the event received by the input event queue 121 using the event filter, and an output event queue 125 for sending an event to the event subscriber who is interested in the event sent through the virtual event channel.

The detailed operation of each element in the virtual event channel unit 120 shown in FIG. 2 will be described in more detail below.

The input event queue 121, which is an element for performing event reception and input event channel management, serves to receive an event generated and sent by an interesting sensor or application determined based on the purpose or use of the virtual event channel.

The output event queue 125, which is an element for performing event generation and output event channel management, serves to send the event received by the input event queue 121 as it is or the event filtered by an event filter to the subscriber.

The subscriber and filter registration unit 122, which is an element for registration and management of the event subscriber and the event filter, severs to register a subscriber who is interested in an event sent through the virtual event channel. If the subscriber is registered, the subscriber can receive all events sent through the virtual event channel.

According to a preferred embodiment of the present embodiment, when the subscriber wants to receive a specific event, not all events, the subscriber can further designate an event filter.

The event filter validation unit 123, which is an element for validation and analysis of the event filter, serves to determine whether the expression formula of the registered event filter has an error in an expression grammar of the filter provided by the virtual event channel.

The event extraction unit 124, which is an element for detection of an overlapping event and extraction of an event, serves to filter all events received by the input event queue 121 using the event filter designated by the subscriber. All events that are physically generated by the sensor are sent to all registered subscribers through event channels thereof.

However, the subscriber may not want to receive all events based on its application purpose. For example, when different two applications use a temperature sensor that periodically measures and transmits the current temperature, one application may collect all temperature information periodically transmitted from the sensor in order to leave a log of a room temperature, and the other application may want to receive an event at a specific temperature in order to control an air conditioner. In this case, although the subscribers (or applications) use the same virtual event channel, the subscribers (or applications) can selectively receive interesting events by setting different event filters.

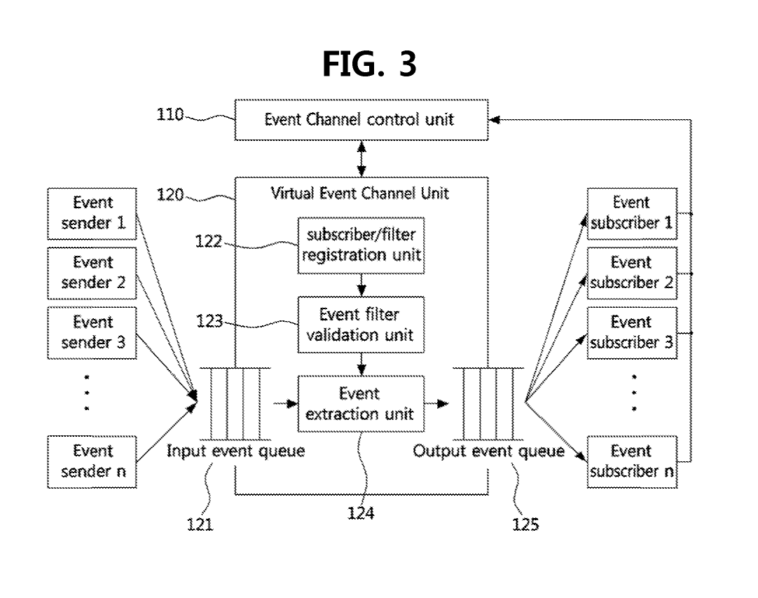

FIG. 3 is a diagram illustrating a virtual event channel configuration method in accordance with another preferred embodiment of the present invention in association with the configuration of a virtual event channel unit in accordance with a preferred embodiment of the present invention.

The virtual event channel unit in accordance with the present invention may combine event channels of a plurality of event senders and send events to a plurality of subscribers.

First, the virtual event channel unit 120 requests a subscription to an event sender (e.g., a physical sensor, event-based application, or another virtual event channel), which sends an interesting event, and receives the event from the event sender.

An event subscriber (e.g., an event-based application or another virtual event channel), which is interested in an event sent from a virtual event channel, registers itself as a subscriber to the most interesting virtual event channel unit among various virtual event channel units, which are included in the virtual event channel configuration system 100, through the event channel control unit 110.

Here, during the registration, the event subscriber may further register an event filter, and thus the event subscriber does not receive all events provided by the virtual event channel but can selectively receive a filtered event.

The subscriber and filter registration unit 122 registers and manages the event subscriber information and the event filter in response to the subscriber's request. The event filter validation unit 123 validates and analyzes the event filter of the registered event subscriber. The event extraction unit 124 identifies the analyzed filter and event subscriber information, detects an event, and transfers the event to the output event queue 125. Then, the output event queue 125 sends the received event to the corresponding event subscriber.

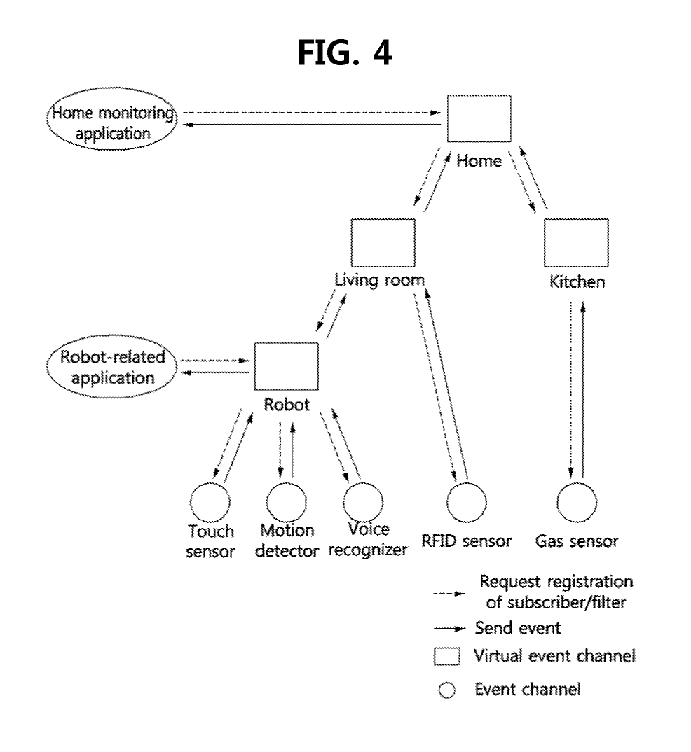

FIG. 4 is a diagram illustrating an example of the configuration of a virtual event channel through a combination of event channels in accordance with a preferred embodiment of the present invention.

As shown in FIG. 4, various types of physical sensors may be provided in various places in a context-aware framework. For example, a gas sensor may be provided in a kitchen and a robot and a radio frequency identification (RFID) sensor may be provided in a living room according to the layout of a house. The robot may include a touch sensor, a motion detector using a camera, a voice recognizer using a microphone, etc.

When there are various service-providing applications in a house, each application registers as a subscriber to event channels of all sensors or another apparatus in order to collect information required for its application and performs a filtering process, if necessary.

However, when the virtual event channel is configured as shown in FIG. 4 according to the space or the purpose of the application, once the event-based applications are registered as subscribers of the virtual event channel, not the individual sensors or events, according to purposes of the applications, the event-based applications can receive all events.

For example, as shown in FIG. 4, when a home monitoring application and a robot-related application are provided in a home, the home monitoring application should receive information from all sensors installed in the home to monitor the overall status of the home. Thus, if a virtual event channel such as “home” is configured to receive all information of the home, the home monitoring application registers as a subscriber of the virtual event channel such as “home”, thereby receiving all events from the robot-related sensors of the living room (such as the touch sensor, the motion detector, the voice recognizer, etc), the RFID sensor, and the gas sensor of the kitchen.

Moreover, a robot-related application is mainly interested in events occurring in the robot, unlike the home monitoring application, since the robot-related application provides a service using a robot. Thus, when the robot-related application registers as a subscriber of a virtual event channel such as “robot”, the robot-related application can receive all events related to the robot and provide a robot service using the events.

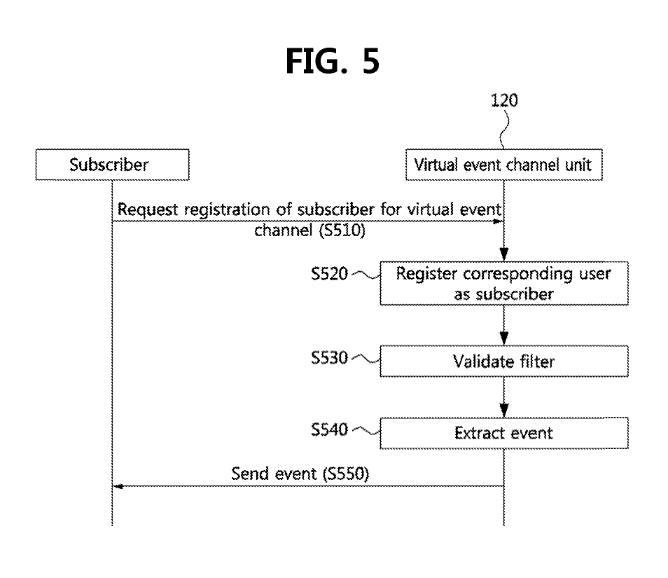

FIG. 5 is a flowchart illustrating a method for sending an event using the configuration of a virtual event channel in accordance with a preferred embodiment of the present invention.

The method for sending an event using the configuration of the virtual event channel in accordance with a preferred embodiment of the present embodiment may generally comprise the step (S510) of requesting registration of a subscriber for a virtual event channel, which is performed by the subscriber, and the step (S520) of registering a corresponding user as a subscriber to a subscriber registration unit, the step (S530) of validating a filter, the step (S540) of extracting an event, and the step (S550) of sending the event to the subscribers, which are performed by the virtual event channel unit 120.

In the step (S510) of requesting registration of the subscriber to the virtual event channel, the user, i.e. the event subscriber, retrieves a virtual event channel required according to the space or the purpose of the application among at least one virtual event channel, which is configured by combining event channels of physical sensors or applications, and requests registration of the subscriber to each virtual event channel required by the user. Here, the user may be an event subscriber, i.e. another virtual event channel, or an event-based application, etc. The subscriber registration request includes a request for registration of a filter desired by the user.

The virtual event channel unit 120, which receives the subscriber registration request from the subscriber, sequentially performs the step (S520) of registering the corresponding user as a subscriber to the subscriber registration unit, the step (S530) of validating the filter, the step (S540) of extracting the event, and the step (S550) of sending the event to the subscribers.

In the step (S520) of registering the corresponding user as a subscriber to the subscriber registration unit, if the user who is interested in the corresponding virtual event channel, i.e. if the application or another virtual event channel requests a subscription, the corresponding user is registered as the subscriber. At this time, if the subscriber selects and registers a filter, the corresponding filter is also registered and managed.

In the step (S530) of validating the filter, if the registered subscriber selects a filter, validation is performed on the filter to determine whether the filter has an expression formula capable of being analyzed by the virtual event channel unit.

In the step (S540) of extracting the event, each event received by the input event queue is inspected individually whether the event is suitable for the filters of the subscribers, and only the event selected after passing through the filter is transferred to the output event queue.

In the step (S550) of sending the event to the event subscribers, the event is sent to the registered subscribers through the output event queue.

As described above, according to the present invention, since the events are received by dynamically combining the interesting event channels, the overhead due to unnecessary event processing can be reduced. Moreover, since the subscriber does not need to find publishers one by one to subscribe to the publishers, each application developer can effectively develop an event-based application. In addition, the present invention can provide device abstraction by configuring a virtual event channel according to the space or the purpose of the application.

While the invention has been particularly shown and described with reference to exemplary embodiments thereof, it will be understood by those of ordinary skill in the art that various changes in form and details may be made therein without departing from the spirit and scope of the invention as defined by the following claims.

What is claimed is:

1. A virtual event channel configuration system comprising at least one virtual event channel unit comprising a combination of a plurality of event channels and an event channel control unit for configuring and managing the at least one virtual event channel unit, wherein each of the at least one virtual event channel unit comprises:
an input event queue for receiving an event from at least one event sender;
a subscriber and filter registration unit for registering and managing an event subscriber who wants to subscribe the sent event and an event filter designated by the event subscriber;
an event filter validation unit for validating whether the event filter designated by the event subscriber has an error in a given event filter grammar; and
an event extraction unit for extracting an event from the events received by the input event queue using the event filter, if the event filter is validated.

2. The virtual event channel configuration system of claim 1, wherein the event channel control unit generates a new virtual event channel unit in response to a request of a user and deletes an unnecessary virtual event channel unit from the at least one virtual event channel unit.

3. The virtual event channel configuration system of claim 2, wherein the user is an event-based application or another virtual event channel.

4. The virtual event channel configuration system of claim 1, wherein each of the at least one virtual event channel unit further comprises an output event queue for sending the event output from the event extraction unit to a registered event subscriber.

5. The virtual event channel configuration system of claim 4, wherein the event subscriber is at least one of the other virtual event channel units or event-based applications.

6. The virtual event channel configuration system of claim 1, wherein the event sender is at least one of physical sensors, event-based applications, and the other virtual event channels.

7. A virtual event channel configuration method for configuring and managing at least one virtual event channel comprising a combination of a plurality of event channels, the method comprising the steps, at each of the at least one virtual event channel, of:
receiving an event from at least one event sender;
registering an event subscriber who wants to subscribe the sent event and an event filter designated by the event subscriber;
validating whether the event filter designated by the event subscriber has an error in a given event filter grammar; and
extracting an event to be sent from the received events using the event filter, if the event filter is validated.

8. The virtual event channel configuration method of claim 7, further comprising sending, at each of the at least one virtual event channel, the extracted event to a registered event subscriber.

9. The virtual event channel configuration method of claim 7, further comprising generating a new virtual event channel in response to a request of a user.

10. The virtual event channel configuration method of claim 7, further comprising deleting an unnecessary virtual event channel from the at least one virtual event channel.

11. The virtual event channel configuration method of claim 9, wherein the user is an event-based application or another virtual event channel.

12. The virtual event channel configuration method of claim 7, wherein the event subscriber is at least one of the other virtual event channel units or event-based applications.

13. The virtual event channel configuration method of claim 7, wherein the event sender is at least one of physical sensors, event-based applications, and the other virtual event channels.

14. An event management apparatus comprising:
an input event queue for receiving an event from at least one event sender;
a subscriber and filter registration unit for registering and managing an event subscriber who wants to subscribe the sent event and an event filter designated by the event subscriber;
an event filter validation unit for validating whether the event filter designated by the event subscriber has an error in a given event filter grammar;
an event extraction unit for extracting an event from the events received by the input event queue using the event filter, if the event filter is validated; and
an output event queue for sending the event output from the event extraction unit to a registered event subscriber.

15. The event management apparatus of claim 14, wherein the user or the event subscriber is an event-based application or another virtual event channel.

16. The event management apparatus of claim 14, wherein the event sender is at least one of physical sensors, event-based applications, and the other virtual event channels.
